(19) United States
(12) Patent Application Publication
(10) Pub. No.: US 2013/0265419 A1
(43) Pub. Date: Oct. 10, 2013

(54) SYSTEM AND METHOD FOR AVAILABLE PARKING SPACE ESTIMATION FOR MULTISPACE ON-STREET PARKING

(71) Applicants: Orhan Bulan, Greece, NY (US); Yao Rong Wang, Webster, NY (US); Zhigang Fan, Webster, NY (US); Edgar A. Bernal, Webster, NY (US); Robert P. Loce, Webster, NY (US); Yeqing Zhang, Penfield, NY (US)

(72) Inventors: Orhan Bulan, Greece, NY (US); Yao Rong Wang, Webster, NY (US); Zhigang Fan, Webster, NY (US); Edgar A. Bernal, Webster, NY (US); Robert P. Loce, Webster, NY (US); Yeqing Zhang, Penfield, NY (US)

(73) Assignee: XEROX CORPORATION, Norwalk, CT (US)

(21) Appl. No.: 13/441,269

(22) Filed: Apr. 6, 2012

(51) Int. Cl. H04N 7/18

(52) U.S. Cl. 348/143; 348/E07.085

(57) ABSTRACT

A method for determining parking availability includes receiving video data from a sequence of frames taken from an image capture device that is monitoring a parking area. The method includes determining background and foreground images in an initial frame of the sequence of frames. The method further includes updating the background and foreground images in each of the sequence of frames following the initial frame. The method also includes determining a length of a parking space using the determined background and foreground images. The determining includes computing a pixel distance between a foreground image and one of an adjacent foreground image and an end of the parking area. The determining further includes mapping the pixel distance to an actual distance for estimating the length of the parking space.

### CROSS REFERENCE TO RELATED PATENTS AND APPLICATIONS

This application is related to co-pending Application Number [Atty. Dkt. No. 20111383-US-PSP], filed herewith, entitled “Video-Based Detector and Notifier For Short-Term Parking Violation Enforcement”, by Edgar Bernal et al.; and co-pending Application Number [Atty. Dkt. No. 20120243-US-PSP], filed herewith, entitled “A Video-Based System and Method for Detecting Exclusion Zone Infractions”, by Orhan Bulan et al., each of which is incorporated herein in their entireties.

### BACKGROUND

The present disclosure relates to a video-based method and system for determining a length of an available parking space at a given instant in time. The disclosure finds application in parking space management. However, it is appreciated that the present exemplary embodiments are also amendable to other like applications.

One challenge that parking management companies face while managing on-street parking is an accurate detection of available spaces. Conventional methods for detecting vehicle occupancy in parking spaces include sensor-based solutions. For example, “puck-style” sensors, shown in FIG. 1, and ultrasonic ceiling or in-ground sensors, shown in FIG. 2, output a binary signal when a vehicle is detected in a parking space. The detected information is wirelessly communicated to interested parties. One disadvantage associated with these sensor-based methods is a high cost for installation and maintenance of the sensors. In addition, the maintenance or replacement of a sensor may reduce parking efficiency if a parking space is made unavailable for the service work.

Another method being explored is a video-based solution. This method is shown in FIG. 3 and includes monitoring on-street parking spaces using non-stereoscopic video cameras. The cameras output a binary signal to a processor, which uses the data for determining occupancies of the parking spaces.

One shortcoming of both technologies is that they are designed for, and limited to, single-space parking configurations. On-street parking can be provided in two different configurations. A first configuration is shown in FIG. 4 and includes single-space parking, also known as stall-based parking, in which each parking space is defined in a parking area by clear boundaries. The parking spaces are typically marked by lines (shown in phantom) that are painted on the road surface to designate one parking space per vehicle. The second configuration is shown in FIG. 5 and includes multi-space parking, in which a long section of street is designated as a parking area to accommodate multiple vehicles. In this configuration, there are no pre-defined boundaries that designate individual parking stalls, so a vehicle can park at any portion extending along the parking area. In many instances, the multi-space parking configurations are more efficient because, when spaces are undesignated, drivers aim to fit more vehicles in a multi-space parking area having a same length as a single-space parking area.

At present, many departments of transportation are transitioning from single-space parking configurations to the multi-space parking configurations. Cities are eliminating parking meters and single-space parking configurations to reduce maintenance and other costs. The sensor-based methods are best suited for parking areas where painted lines typically demark a defined parking space for a single vehicle. However, an incorporation of the sensor-based methods for use in multi-space parking configurations is conceptually difficult and expensive to continue. Accordingly, this transition reduces a need for in-ground and other sensor-based methods.

Given the comparatively lower cost of a video surveillance camera, a video-based solution offers a better value if it is incorporated into a management scheme for monitoring multi-space parking configurations. Another advantage of a video-based solution is that one video camera can typically monitor and track several parking spots, whereas multiple sensors may be needed to reliably monitor one parking space in the single-space parking configuration. Additionally, maintenance of the video cameras is likely to be less disruptive than maintenance of in-ground sensors.

However, there is no known video-based method adapted to analyze frames in a video feed for estimating whether a parking space that appears available can actually fit a vehicle. Because drivers park vehicles at random in multi-space parking configurations, there are sometimes uneven distances left between parked vehicles and the ends of the parking area. Some distances may be shorter than a car-length, thus making an apparent parking space unavailable. Similarly, some distances may be greater than a car-length, thus making a parking space available. A method and a system are needed to distinguish between the two for reliably indicating the availability of a parking space to a user seeking the space.

### BRIEF DESCRIPTION

One embodiment of the present disclosure relates to a method for determining parking availability. The method includes receiving video data from a sequence of frames taken from an image capture device that is monitoring a parking area. The method includes determining parked vehicles in an initial frame of the sequence of frames and setting the background as the initial frame. The method further includes estimating a background image associated with a current frame. The method also includes determining a length of a parking space using the determined background and foreground images. The determining includes computing a pixel distance between a location of a vehicle element in the foreground image and an adjacent vehicle element in the foreground image. The determining further includes mapping the pixel distance to an actual distance for estimating the length of the parking space.

Another embodiment of the present disclosure relates to a system for determining parking availability. The system includes a parking space determination device. The parking space determination device includes a video capture module that is adapted to receive image data corresponding to a sequence of frames each capturing a parking area over a duration of time. The parking space determination device further includes a stationary vehicle detection module that is adapted to detect a parked vehicle in the parking area as a change between a select frame and the background. The parking space determination device also includes a background updating module that is adapted to estimate a background at a given instant of time by applying a predetermined updating factor in a process used to determine the background in each select frame. The parking space determination device includes a distance calculation module that is adapted to calculate an actual distance between the parked vehicle and one of an adjacent parked vehicle and a boundary of the parking area. The parking space determination device also includes a processor that is adapted to implement the modules.

### BRIEF DESCRIPTION OF THE DRAWINGS

FIG. 1 shows a “puck-style” sensor-based method for detecting parking space occupancy according to the PRIOR ART.

FIG. 2 shows an ultrasonic sensor-based method for detecting parking space occupancy according to the PRIOR ART.

FIG. 3 shows a video-based method for detecting parking space occupancy according to the PRIOR ART.

FIG. 4 shows a single-space parking configuration.

FIG. 5 show a multiple-space parking configuration.

FIG. 6 is a schematic illustration of a parking space determination system according to one embodiment.

FIG. 7 is a flowchart describing an overview of a method for determining an available parking space.

FIG. 8 is a flowchart describing a detailed process for detecting a vehicle in a parking area.

FIG. 9A is a flowchart describing a process for updating a background.

FIG. 9B is a flowchart describing a process for determining a length of the parking space.

FIG. 10 shows an example scenario where the present disclosure can be applied to determine spaces.

FIG. 11-13 shows an example implementation of the present disclosure.

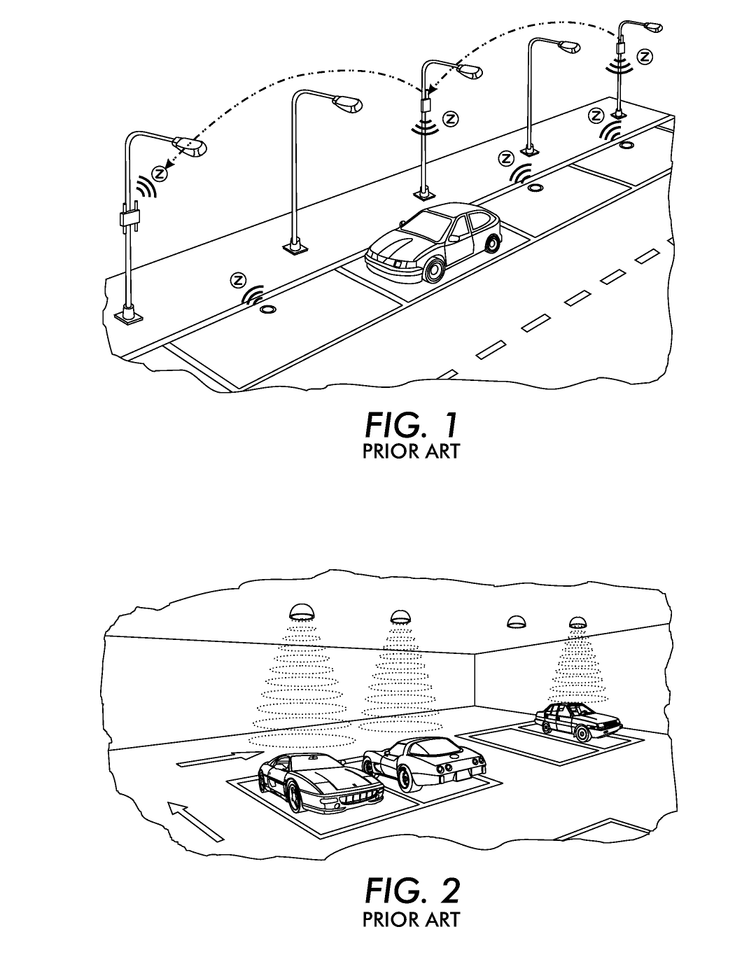

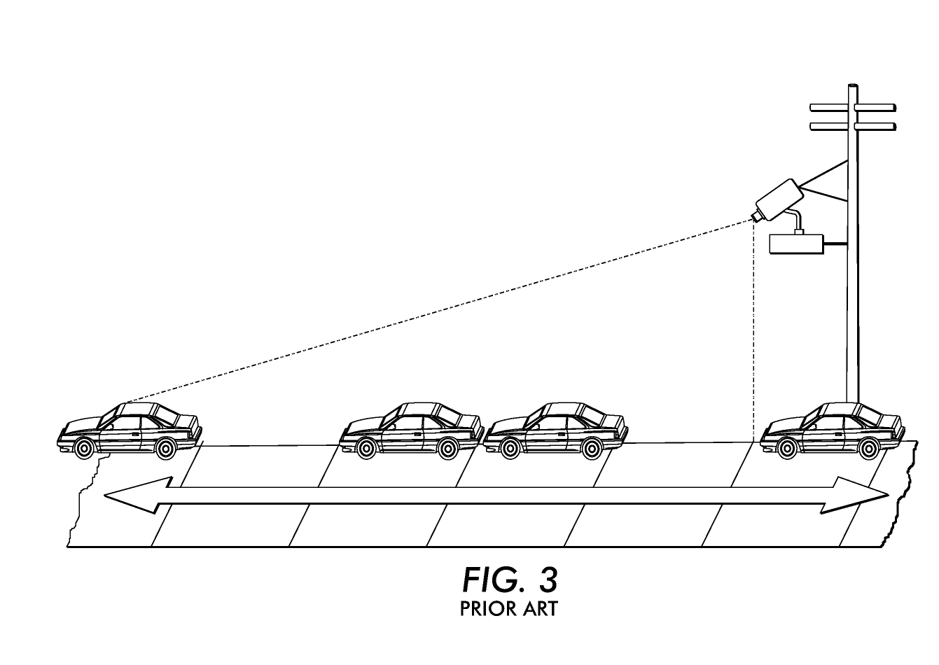

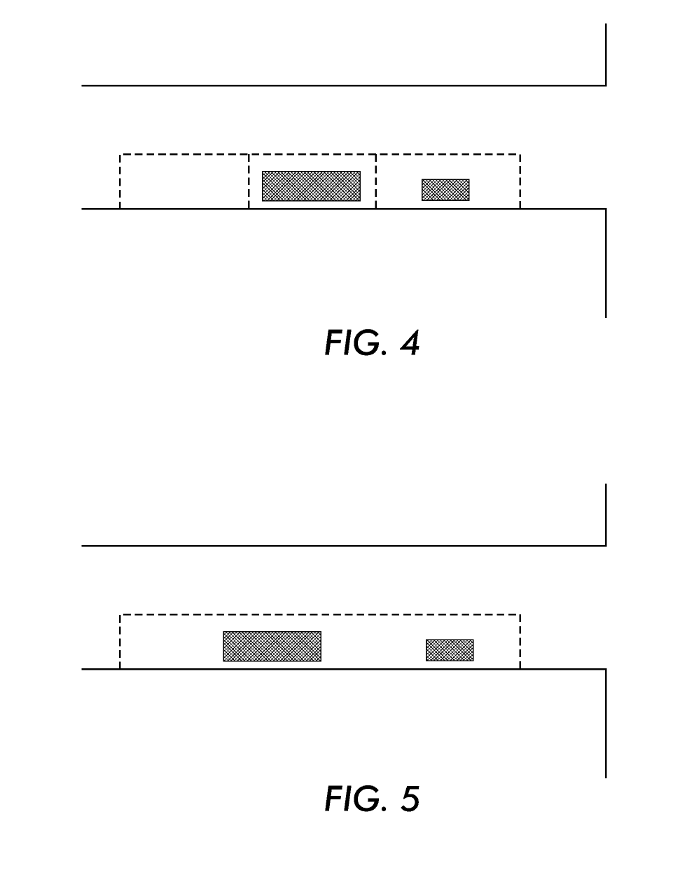

### DETAILED DESCRIPTION

The present disclosure relates to a video-based method and system for determining a length of an available parking space at a given instant in time. The system includes an image capture device that monitors parking spaces and processes video data, or transmits the video data to a central processor, for determining an availability of the parking spaces based on distance computations.

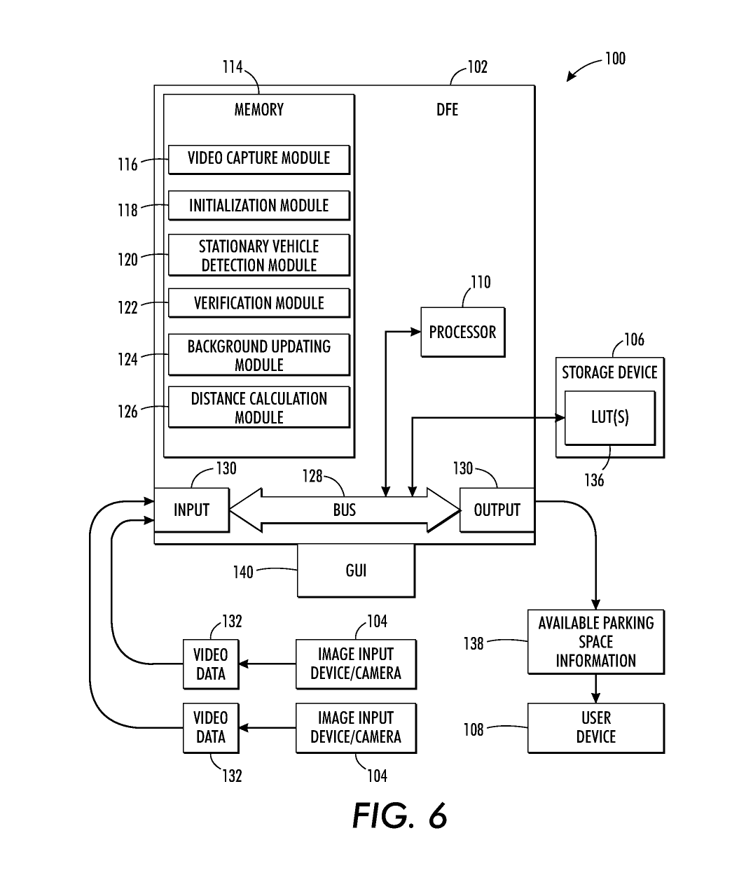

FIG. 6 is a schematic illustration of a parking space determination system 100 in one exemplary embodiment. The system includes a determination device 102, an image capture device 104, and a storage device 106, which may be linked together by communication links, referred to herein as a network. In one embodiment, the system 100 may be in further communication with a user device 108. These components are described in greater detail below.

The determination device 102 illustrated in FIG. 6 includes a controller 110 that is part of or associated with the determination device 102. The exemplary controller 110 is adapted for controlling an analysis of video data received by the system 100 by classifying the pixels in each static frame. The controller 110 includes a processor 112, which controls the overall operation of the determination device 102 by execution of processing instructions that are stored in memory 114 connected to the processor 112.

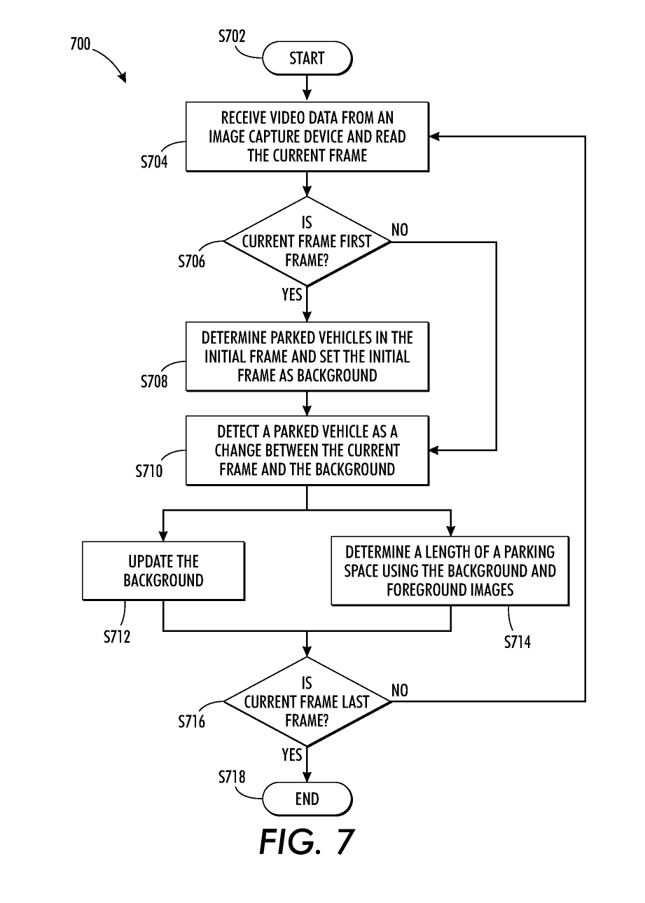

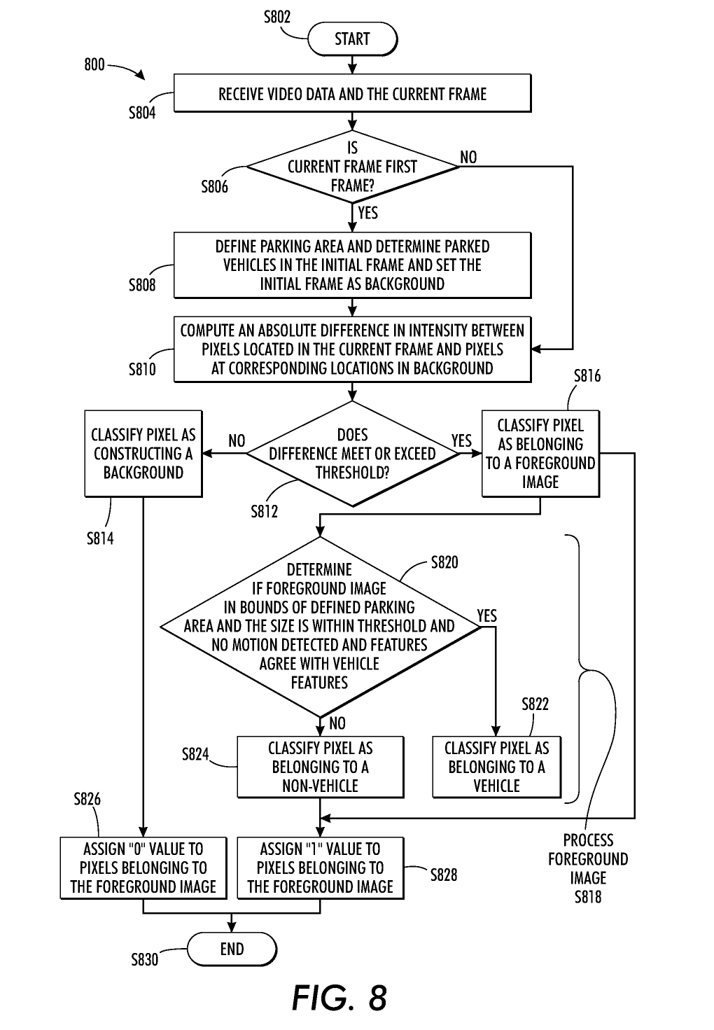

The memory 114 may represent any type of tangible computer readable medium such as random access memory (RAM), read only memory (ROM), magnetic disk or tape, optical disk, flash memory, or holographic memory. In one embodiment, the memory 114 comprises a combination of random access memory and read only memory. The digital processor 112 can be variously embodied, such as by a single-core processor, a dual-core processor (or more generally by a multiple-core processor), a digital processor and cooperating math coprocessor, a digital controller, or the like. The digital processor, in addition to controlling the operation of the determination device 102, executes instructions stored in memory 114 for performing the parts of the method outlined in FIGS. 7 and 8. In some embodiments, the processor 112 and memory 114 may be combined in a single chip.

The determination device 102 may be embodied in a networked device, such as the image capture device 104, although it is also contemplated that the determination device 102 may be located elsewhere on a network to which the system 100 is connected, such as on a central server, a networked computer, or the like, or distributed throughout the network or otherwise accessible thereto. The video data analysis and parking space determination phases disclosed herein are performed by the processor 112 according to the instructions contained in the memory 114. In particular, the memory 114 stores a video capture module 116, which captures video data of a parking area of interest; an initialization module 118, which detects vehicles in a given static frame of the video data; a stationary vehicle detection module 120, which detects vehicles that are in the parking area of interest; a verification module 122, which verifies that the detected vehicles are parked in the area of interest; a background estimation module 124, which estimates a background of a captured scene at a given instant in time; and, a distance calculation module 126, which calculates the actual distance between the parked vehicles. Embodiments are contemplated wherein these instructions can be stored in a single module or as multiple modules embodied in the different devices. The modules 116-126 will be later described with reference to the exemplary method.

The software modules as used herein, are intended to encompass any collection or set of instructions executable by the determination device 102 or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server (not shown) or other location to perform certain functions. The various components of the determination device 102 may be all connected by a bus 128.

With continued reference to FIG. 6, the determination device 102 also includes one or more communication interfaces 130, such as network interfaces, for communicating with external devices. The communication interfaces 130 may include, for example, a modem, a router, a cable, and/or Ethernet port, etc. The communication interfaces 130 are adapted to receive video and/or image data 132 as input.

The determination device 102 may include one or more special purpose or general purpose computing devices, such as a server computer or digital front end (DFE), or any other computing device capable of executing instructions for performing the exemplary method.

FIG. 6 further illustrates the determination device 102 connected to an image source 104 for inputting and/or receiving the video data and/or image data (hereinafter collectively referred to as “video data”) in electronic format. The image source 104 may include an image capture device, such as a camera. The image source 104 can include one or more surveillance cameras that capture video data from the parking area of interest. For performing the method at night in parking areas without external sources of illumination, the cameras 104 can include near infrared (NIR) capabilities at the low-end portion of a near-infrared spectrum (700 nm-1000 nm).

In one embodiment, the image source 104 can be a device adapted to relay and/or transmit the video captured by the camera to the determination device 102. For example, the image source 104 can include a scanner, a computer, or the like. In another embodiment, the video data 132 may be input from any suitable source, such as a workstation, a database, a memory storage device, such as a disk, or the like. The image source 104 is in communication with the controller 110 containing the processor 112 and memories 114.

With continued reference to FIG. 6, the system 100 includes a storage device 106 that is part of or in communication with the determination device 102. In a contemplated embodiment, the determination device 102 can be in communication with a server (not shown) that includes a processing device and memory, such as storage device 106, or has access to a storage device 106, for storing look-up tables (LUTs) that map pixel distance data to actual distance data and select vehicle class and length data to actual distance data. The storage device 106 includes a repository, which stores at least one (previously generated) LUT 136, such as a distance conversion table for each particular camera used by the system 100 and a table associating vehicle lengths with vehicle classes.

With continued reference to FIG. 6, the video data 132 undergoes processing by the determination device 102 to output a determination 138 regarding parking space availability to an operator in a suitable form on a graphic user interface (GUI) 140 or to a user device 108, such as a smart phone belonging to a driver in transit or to vehicle computer and/or GPS system, that is in communication with the determination device 102. The GUI 140 can include a display, for displaying information, such as the parking space availability and dimension, to users, and a user input device, such as a keyboard or touch or writable screen, for receiving instructions as input, and/or a cursor control device, such as a mouse, trackball, or the like, for communicating user input information and command selections to the processor 112.

FIG. 7 is a flow-chart describing an overview of the method 700 performed by the system 100 discussed above. The method 700 starts at S702. The video capture module 116 receives video data from a sequence of frames taken from the image capture device 104 monitoring a parking area at S704. The initialization module 118 determines whether the current frame is the first frame at S706. In response to the current frame not being the first frame in the sequence, the module 118 transmits the video data to the stationary vehicle detection module 120 for performing S710. In response to the current frame being the first frame in the sequence, the initialization module 118 determines parked vehicles in the initial frame and sets the initial frame as a background at S708. The stationary vehicle detection module 120 detects a parked vehicle in the parking area as a change between the current frame and the background at S710. The background updating module 124 updates the background at S712. The distance calculation module 126 determines a length of a parking space using the determined background and foreground images at S714. The system then determines whether the current frame is the last frame at S716. In response to the current frame not being the last frame in the sequence, the method returns to S704 to repeat the above-described process on the next frame. In response to the current frame being the last frame in the sequence, the method ends at S718.

FIG. 8 is a detailed flowchart describing the method 800 for detecting a vehicle in a parking area. The method starts at S802. The video capture module 116 receives video data from a sequence of frames taken from the image capture device 104 at S804. The initialization module 118 determines whether the current frame is the first frame at S806. In response to the current frame not being the first frame in the sequence, the module 118 transmits the video data to the stationary vehicle detection module 120 for performing S810. In response to the current frame being the first frame in the sequence, the initialization module 118 performs an initialization process by detecting a parked vehicle in the frame and setting the first frame as background. The initialization process can be performed at the start of the video feed or at a later frame. However, other modules always follow the initialization module.

The initialization module 118 estimates vehicle occupancy in the parking area at a start of the sequence using the static image captured in the initial frame. Generally, the initialization module 118 determines the positions of the parked vehicles in the initial frame to detect objects and/or vehicles that are already present in the parking area. More specifically, the module 118 defines the parking area and uses the defined parking area to determine the vehicles that are parked in the initial frame at S808. In one embodiment, the module 118 can receive input designating the parking area in the video data with a boundary. In another embodiment, the parking area can be defined by generating a map and then defining a location using the map. For example, the system can generate the map for associating two-dimensional pixel coordinates of the image with three-dimensional actual coordinates of the parking area. For defining the location of the parking area in the initial image, the actual coordinates can be mapped to the pixel coordinates.

In one embodiment, the initialization module 118 uses a training-based classifier to classify pixels as belonging to vehicles and non-vehicles. The classified pixel information is used in conjunction with coordinate data, which defines a parking area that is used to estimate occupancy. After the parked vehicles are determined, the background is initialized by setting the background as the initial frame. The background is used by the stationary vehicle detection module 120 to update a background in a current frame.

The stationary vehicle detection module 120 detects vehicles that park in the parking area or leave the parking area. Generally, the stationary vehicle detection module 120 highlights objects in the foreground, i.e., in the parking area of interest, of a video sequence when the image capture device is used to capture the video data. Once the background is estimated, the vehicles that park in the parking area or leave the parking area, after the initialization process at S808, are detected by subtracting the selected frame from the estimated background and applying thresholding and morphological operations on the difference image. At each frame, the stationary vehicle detection module 120 detects movement of vehicles using temporal difference methods to check whether the detected vehicle is stationary or in motion. In the contemplated embodiment, a double-difference algorithm can also be used to detect objects in motion within the field of view of the camera.

With continued reference to FIG. 8, in one embodiment, the stationary vehicle detection module 120 computes an absolute difference in an intensity between pixels located in the current frame and pixels at corresponding locations in the background at S810. The difference between the selected frame and the background is typically calculated only at positions where no motion is detected. The reason why the difference is calculated at only these positions is because motion resulting from possible occlusions and vehicular movement, such as, for example, due to a vehicle moving in and/or out of a space in a frame, might provide unreliable information regarding vehicle occupancy. The difference in intensity for each pixel at corresponding locations in the background and the current frame is then compared to a predetermined threshold at S812. In response to the difference not meeting the threshold, the pixel in the current frame is classified as constructing a background at S814. In response to the difference meeting the threshold, the pixel is classified as belonging to a foreground image at S816.

A verification module 122 can perform further processing on the foreground image at S818 to determine whether the foreground image pixels belong to one of a vehicle and a non-vehicle. When an object or a set of pixels, having a size that is reasonably large enough to be considered as a potential vehicle entering a scene is classified as a foreground change in the parking area, the verification module 122 applies an algorithm to determine if the detected object is actually a vehicle or a false detection at S818. In one embodiment, the processing can include occlusion detection. In another embodiment, the processing can include shadow suppression. In a further embodiment, the processing can include morphological operations. There is no limitation made herein directed toward the type of processing that can be performed for classifying the foreground pixels.

In the discussed embodiment, occlusion detection can be performed at S818 using the parking area that was defined in the initial frame of the video data at S808. The verification module 122 determines whether the pixels belonging to the foreground image are contained within the bounds of the defined parking area at S820. In another embodiment, the module 122 can alternatively determine whether the pixels belonging to the foreground image satisfy predetermined size thresholds at S820. Furthermore, the module 122 can determine whether the features, such as location, color, and shape characteristics, of the foreground object substantially match the features of the vehicle at S820. For these embodiments, the stationary vehicle detection module 122 can generate a binary image of the foreground object. Using the binary image, the verification module 122 can analyze each object to determine if the object is in-fact a vehicle based on its size, position, and motion characteristics. In a further embodiment, the module 122 can determine whether no motion is detected in the frame at S820. In yet another embodiment, the module 122 can perform a combination of the determinations. In response to the foreground image being contained within the defined parking area or satisfying any of the above determinations, the pixels of the foreground image are classified as belonging to the vehicle at S822. In response to the foreground image being only partially contained in the parking area, the pixels of the foreground image are classified as belonging to a non-vehicle, such as, for example, an occlusion at S824.

With continued reference to FIG. 8, after the pixels in the selected frame are classified, the stationary vehicle detection module 120 forms a binary mask by assigning a “0” value to the pixels corresponding to locations classified as belonging to the background construct at S826 and a “1” value to pixels corresponding to locations classified as belonging to the vehicles in the foreground image at S328. The method ends at S830.

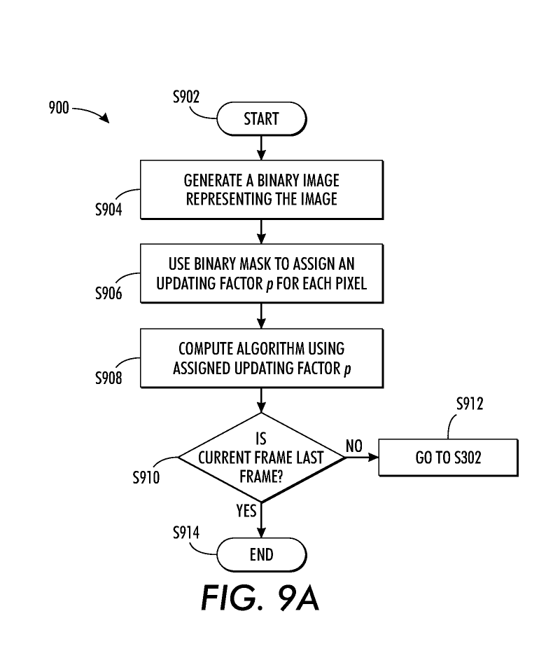

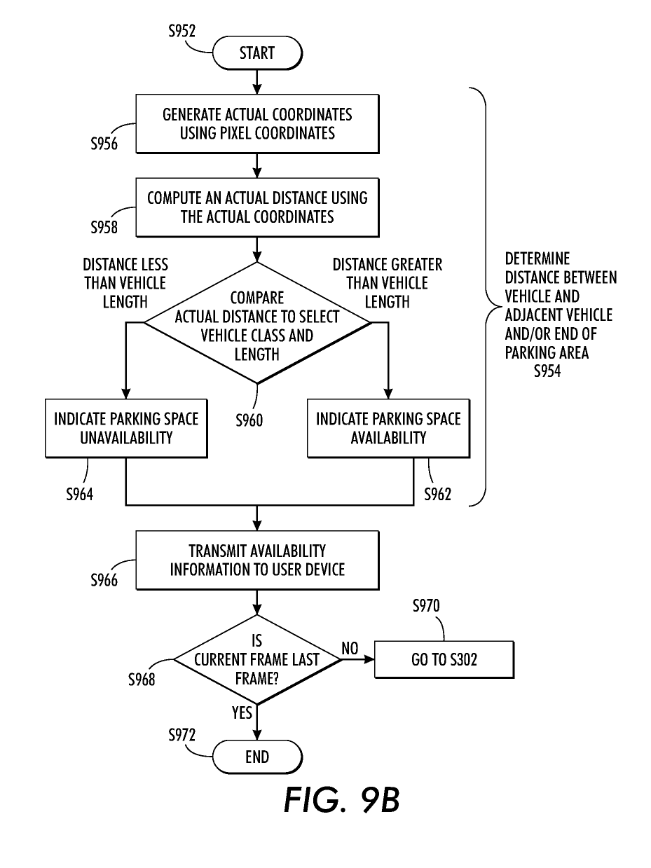

Now referring to FIG. 9A, a flowchart is shown for describing a process for updating a background. The stationary vehicle detection module 120 provides the pixel classifications to the background updating module 124 in the form of a binary mask. More specifically, the stationary vehicle detection module 120 uses the assigned values to generate a binary image representing the current frame at S904. The binary mask can have the same pixel dimensions as the captured video. The stationary vehicle detection module 120 provides the binary mask to the background updating module 124.

The background updating module 124 uses this binary information for calculating an algorithm, which is used to update the background in each next frame of the sequence to determine when the initially parked vehicle subsequently moves away from and/or leaves the parking space or when a new vehicle enters the scene. In this manner, embodiments are contemplated as not including the initialization module 118 because the background updating module 124 updates and/or self-corrects the system for undetected or missed vehicles as soon as these vehicles leave the scene. More specifically, the system 100 can omit the initialization module 118 when an image of the background is available without having any foreground object. In this manner, the background updating module 124 can perform the process of background removal analogous to the process performed by the stationary vehicle detection module 120, for example, by computing an absolute intensity/color difference between the known background image and each image in the video sequence. Pixels are classified as belonging to a background construct for a computed difference that is below a threshold. There is no limitation made herein to a technique that can be used. There are several techniques that can be used for determining background estimation, such as, for example, known processes based on running frame average; Gaussian mixture models; and eigen backgrounds, which use principal component analysis and a computation of running averages that gradually update the background in new frames.

The background updating module 124 is used to update the background, frame-by-frame, for each frame that follows the initial frame of the sequence. The background is defined as and/or includes buildings, roads, or any stationary objects that surround the parked vehicles in the captured video data. The background updating module 124 determines the background in a current (i.e., select) frame of the sequence by applying an updating factor p (i.e., a learning factor) that is computed for each pixel of a preceding frame to an algorithm used to compute the background of a current frame. In other words, the first updating factor p used in an algorithm is based on the classification of pixels resulting from a comparison (i.e. background removal) between a select frame and the background. For each subsequent frame, the process for determining the updating factor p is repeated by comparing a current frame with the background of a preceding frame and then the algorithm is computed for determining the background of the current frame. A difference between the current frame and the background of the preceding frame is determined to detect the vehicles.

One aspect of the present disclosure is that the updating factor p varies depending on the classification assigned to the pixel at S814 and S816, as belonging to the foreground and background image (and hence the binary value assigned to the pixel at S826, and S828), in the selected frame. With continued reference to FIG. 9A, the binary mask that is received by the background updating module 124 is used as input for determining an updating factor p for each pixel at S906. The selection of the updating factor p is particularly suited for detecting vehicles that park in the parking area during the time period that the sequence of frames is captured. In one embodiment, the following criteria can be used to set the updating factor p for each pixel at each time instant. The updating factor p can be assigned a “0” value for a pixel indexed by (i, j) if the binary output indicated that a foreground image was captured in the preceding frame. In this manner, the updating factor p is “0” for any pixel belonging to a parked vehicle (resulting from the initialization module 118), a determined occlusion, or a detected movement. Pixels belonging to the background construct at S814 do not get updated for corresponding locations in the sequence under these conditions. The updating factor p can be assigned a “1” value for a pixel indexed by (i, j) in frames that no longer include a previously stationary vehicle. In other words, the updating factor p is “1” when a parked vehicle has left the parking area. Accordingly, the background is recovered immediately by setting the updating factor to “1” for pixels at the location previously occupied by the vehicle. For all other pixels, the learning parameter is set to a value between zero and one (0≦p≦1) to update the background gradually. In one contemplated embodiment, the value can be set to 0.01.

One aspect of the disclosure is that the system applies the learning element to the updating factor p and uses the updating factor p as input when computing an algorithm used for background estimation at S908. In this algorithm, the background is initialized as the initial frame in the sequence of frames and gradually updates with each subsequent frame in the sequence. The algorithm is represented by the equation:

Bₜ₊₁=p*Fₜ₊₁+(1−p)*Bₜ

where Bₜ represents the background at time t, such as a background in the initial frame or the preceding frame;
Fₜ₊₁ is the select frame at time t+1, such as the current frame; and,
0≦p≦1 is the image updating factor.

Based on the above-mentioned values for the updating factor p that are assigned to each pixel, if the updating factor p is “1” for all pixels in a frame, then the estimated background at any given time is equal to the preceding frame. In other words, by applying the updating factor p=1 in the algorithm, the output value is indicative of a change in vehicle positions in the current frame from that in the preceding frame. If the updating factor p is selected as “0”, the background at time t+1 remains the same as the background at time t. In other words, by applying the updating factor p=0 in the algorithm, the output value is indicative that there is no change in vehicle positions in the current and the preceding frame. Accordingly, the updating factor p controls the updating rate of the background.

The system then determines whether the current frame is the last frame in the sequence at S910. In response to the current frame not being the last frame in the sequence, the updating method returns to S704 to repeat the above-described process on the next frame at S912. In response to the current frame being the last frame in the sequence, the updating method ends at S914.

Now referring to FIG. 9B, a flowchart is shown for describing a process for determining a length of the parking space. Simultaneous to the background being updated using the process described in FIG. 9A, the distance calculation module 126 determines length of the available parking spaces in the parking area at the time instant when the current frame is captured. As mentioned, there are sometimes uneven distances left between parked vehicles and the ends of a parking area. Some distances are shorter than a vehicle-length, thus making a parking space unavailable despite the appearance of it being available. Similarly, some distances are greater than a vehicle-length, thus making the parking space available for select vehicles having and/or satisfying the particular length. One aspect of the disclosure is that it distinguishes between the two for reliably indicating the availability of a parking space to a user seeking the space.

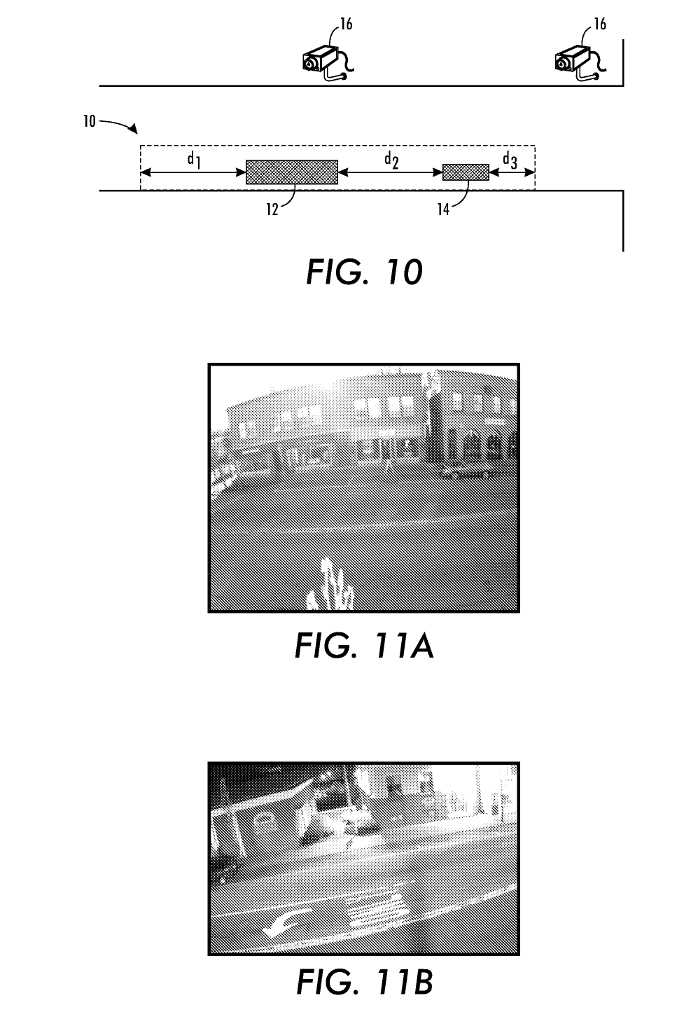

FIG. 10 shows an example scenario where the present disclosure can be applied to determine spaces. A multi-space parking area 10 is shown in phantom as not including any marked lines that designate separate parking stalls. A truck 12 and a vehicle 14 are parked in the area 10 that is being monitored by at least one image capture device 16. The number of devices 16 that are deployed to cover the parking area 10 can vary depending on the size of the parking area. The captured video data is simultaneously transferred to the determination device 102 (or a similar performing central processor), which calculates and reports the lengths (d₁, d₂ and d₃) of the available parking spaces to interested parties.

Continuing with FIG. 9B, using the binary values provided at S826 and S828, the distance calculation module 126 estimates an actual length (and/or depth) of the available parking space. The distance calculation module 126 estimates the actual length by mapping a distance measured by pixel coordinates to actual coordinates.

As mentioned, the system generates an LUT when the image capture device is first installed and calibrated. The LUT associates parameters of the calibrated image capture device that link the two-dimensional pixel coordinates in the video data with three-dimensional coordinates in the actual parking area.

The distance calculation module 126 determines the distance between a location of an element in the foreground image, such as the stationary vehicle, and another element in the foreground image, such as an adjacent stationary vehicle or the end of the parking area at S954. The distance calculation module then accesses the LUT that is stored in the storage device to map the pixel distance to an actual distance. Generally, the pixel coordinates of (u, v) of the stationary vehicles and/or ends of the parking area are input into the system and used to output actual coordinates (x,y,z) at S956. The output coordinates of the stationary vehicle and the adjacent stationary vehicle and/or end are then used to compute an actual (i.e., usable) distance and/or length between the two at S958. The distance value can then be used to determine an availability of the parking space, i.e., whether the parking space can be used.

With continued reference to FIG. 8, the distance calculation module 126 compares the actual distance to one of a select vehicle class and length at S960. For example, an LUT may be used to compare the lengths of vehicles of certain classes, such as a compact car, a large sedan, a truck, and a motorcycle, etc., with the actual distance. Based on the comparison, the module 126 determines whether the actual distance is greater than the one of the vehicle class and select length. In response to the actual distance being greater than the one of the vehicle class and select length, the parking space is classified as being an available parking space for vehicles of the select class and length at S962. In response to the actual distance being less than the one of the vehicle class and select length, the parking space is classified as being an available parking space for vehicles of the select class and length at S964.

In one embodiment, the system can output the parking space availability information to a user device at S966. In one embodiment, the information can be transmitted to all vehicles that subscribe to the service and/or are determined via GPS data to be within a region proximate the parking space. In another embodiment, the information can be transmitted in response to a user-device querying the system for the information. The information can be communicated to the vehicle computer system or to a smart phone including a specialized application. The information can include information indicating the vehicle type that is best suited for the space based on the determined dimensions. Information can be further processed to include statistics such as a number of vehicles that can fit in the estimated available parking space. Accordingly, the output of the distance calculation module 126 is the total number of available and usable parking spaces, on a frame by frame basis, as well as locations.

The system then determines if the current frame is the last frame at S968. In response to the current frame not being the last frame in the sequence, the method returns to S704 to repeat the above-described process on the next frame. In response to the current frame being the last frame in the sequence, the method ends at S972.

Although the method 300 is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system 100, wherein the disclosure is not limited to the specific applications and embodiments illustrated and described herein.

Example Implementation

The disclosure was tested on two video sequences that were taken with a Vivotek IP8352 surveillance camera that is readily available in the market. The videos have a frame rate of 30 frames per second (fps). The videos were captured on a Webster Village (New York) street during both daytime and night time hours. FIGS. 11A and 11B show sample video frames that illustrate the setup of the camera system and the configuration of the parking area that was being monitored for each video sequence. The daytime video monitored the parking area for almost 45 minutes and the night time video monitored the parking area for 15 minutes. In both video sequences, several vehicles parked and left the parking area.

The vehicle in the daytime video sequence depicted in FIG. 10a remained parked for the duration of the experiment. Similarly, the vehicle, which is shown partially in the view, in the night time video in FIG. 10b stayed there during the duration of the experiment. The initialization module 118 determined the vehicles parked at startup and at any desired reference frame. For purposes of performing the experiment, the algorithm was manually initialized for convenience. The vehicle in the night time video was not initialized because it was only partially in the view of camera.

After initialization, the initial frame was set as the background. If there is motion detected in the first frame, the background can be set to the first frame at which no motion is detected. The background was then updated using the algorithm described for the background updating module 124 to detect the stationary vehicles that were parked in the parking area.

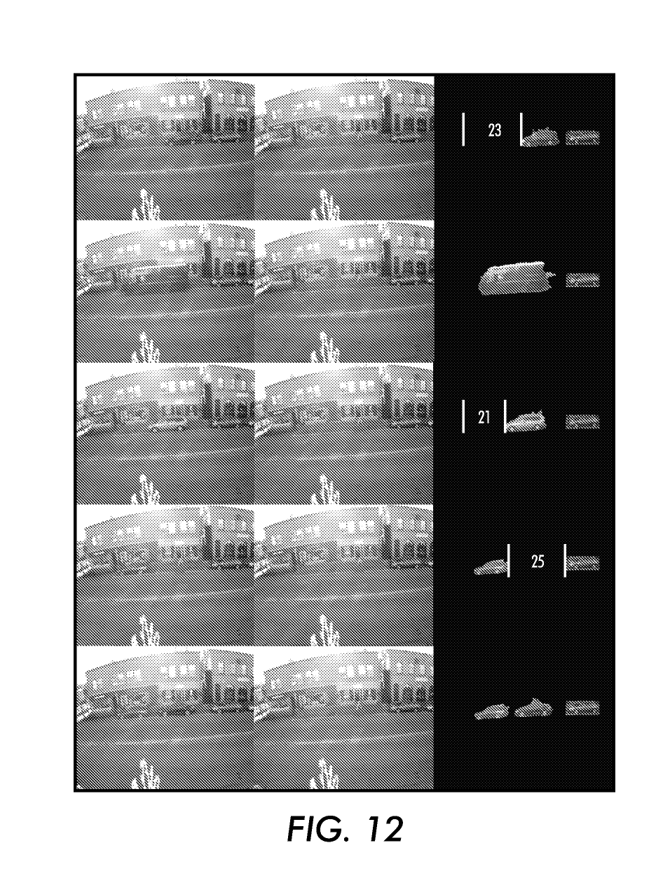

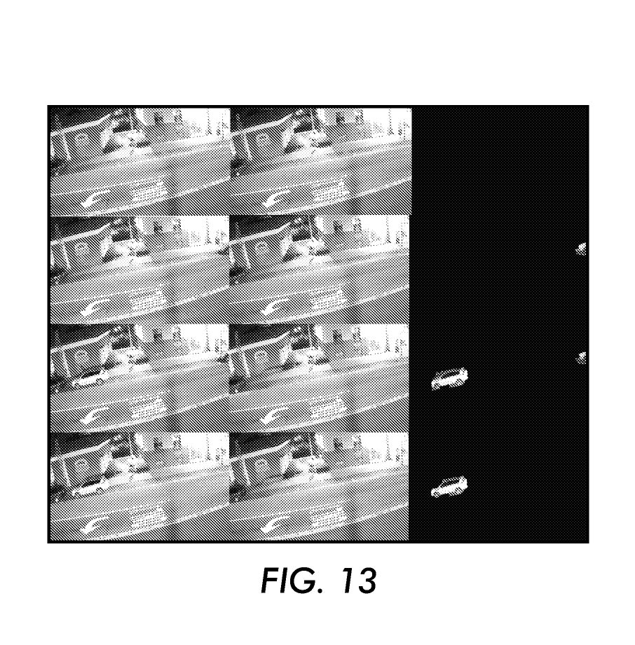

FIGS. 12 and 13 show the results of the algorithm in terms of its ability to detect stationary vehicles in the parking area for daytime and night time video sequences, respectively. In the figures, the images in the first column show the current frame and those in the second column contain the estimated background at that time. The images in the last column show the detected stationary vehicles in the parking area. When motion was detected in the region, the detected stationary vehicles were not updated until the next frame in the sequence indicated that no motion was detected. As shown in the figures, the stationary vehicles parked in the parking area were accurately detected.

The boundaries of the detected vehicles were then fed into the distance calculation module 126, which estimated the actual distance between the stationary vehicles and simultaneously reported the available parking distance to the interested parties. Additionally, the images on the rightmost column in FIG. 12 show the estimated parking space that was determined as being available because it was greater than 15 feet.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for determining parking availability, the method comprising:
receiving video data from a sequence of frames taken from an associated image capture device monitoring a parking area;
estimating a background image associated with a current frame;
determining a foreground image from the background image and the current frame;
determining a length of a parking space between adjacent vehicles in the foreground image.

2. The method of claim 1, wherein the determining the length includes:
detecting parked vehicles in the foreground image;
computing a pixel distance between a location of a vehicle in the foreground image and an adjacent vehicle in the foreground image, and
mapping the pixel distance to an actual distance for estimating the length of the parking space.

3. The method of claim 2 further comprising:
comparing the actual distance to one of a vehicle class and select length;
determining if the actual distance is greater than the one of the vehicle class and select length; and,
in response to the actual distance being greater than the one of the vehicle class and select length, classifying the parking space as an available parking space for the one of the vehicle class and select length.

4. The method of claim 2, wherein the detecting parked vehicles in the foreground image includes:
processing the foreground image; and,
based on the processing, assigning pixels belonging to the foreground image to one of a vehicle and non-vehicle.

5. The method of claim 1, wherein the estimating the background image associated with the current frame includes:
determining whether the current frame is an initial frame of the sequence of frames;
in response to the current frame being the initial frame, initializing the background image; and
updating a background in each of the sequence of frames following the initial frame.

6. The method of claim 5, wherein the initializing the background image is performed by setting the background image to one of the current frame and a pre-constructed background image.

7. The method of claim 5, wherein the updating the background is performed by a process selected from a group consisting of: running frame average; Gaussian mixture model estimation; and, eigenbackground.

8. The method of claim 1, wherein the determining the foreground image includes:
computing an absolute difference in an intensity between pixels located in a select frame and pixels at corresponding locations in the background image of a preceding frame;
determining if the difference meets or exceeds a threshold; and,
classifying the pixels in the select frame based on the difference and the threshold.

9. The method of claim 8, wherein the classifying includes:
in response to the threshold not being met or exceeded, classifying a pixel as belonging to a background image;
in response to a threshold being met or exceeded, classifying the pixel as belonging to a foreground image.

10. The method of claim 8 further comprising:
after determining background and foreground images, providing a binary mask using the classified pixels, the providing including:
assigning a “0” value to the pixels corresponding to locations classified as belonging to a background image, and
assigning a “1” value to pixels corresponding to locations classified as belonging to a foreground image.

11. The method of claim 10 further comprising:
generating a binary image using the “0” and “1” pixels; and,
using the binary image and the current frame for updating the background in frames following an initial frame of the sequence.

12. The method of claim 1 further comprising detecting parked vehicles in an initial frame of the sequence of frame, the detecting includes:
defining the parking area in the initial frame of the video data;
determining whether a foreground element is contained within bounds of the defined parking area;
determining whether a size of the foreground element is in the margin of a typical vehicle size on the image plane;
in response to the foreground element being contained within the defined parking area and in the margin of a vehicle size, classifying the pixels of the foreground element as belonging to the vehicle;
in response to the foreground element being only partially contained in the parking area or not in the margin of a vehicle size, classifying the pixels of the foreground element as belonging to the non-vehicle.

13. The method of claim 1, wherein the updating includes:
applying a predetermined updating factor p in an algorithm used to determine a background in the sequence of frames following an initial frame, wherein the updating factor p varies depending on a classification of a pixel belonging to the foreground and background.

14. The method of claim 13, wherein the algorithm includes a function Bₜ₊₁=p*Fₜ₊₁+(1−p)*Bₜ, wherein Bₜ is the background at time t, Fₜ₊₁ is a frame at time t+1, and p is the updating factor for the pixel, wherein the updating factor is selected from a group consisting:
a “0” value if a vehicle is detected at the pixel location;
a “1” value if another object is detected at a pixel location previously occupied by a vehicle; and,
a value 0≦p≦1 for all other pixels.

15. The method of claim 1 further comprising:
verifying a classification of a vehicle in the sequence of frames following an initial frame.

16. The method of claim 1 further comprising:
communicating an availability of the parking space to a user device.

17. A computer program product comprising tangible media which encodes instructions for performing the method of claim 1.

18. A system for determining parking availability comprising:
a parking space determination device comprising memory which stores instructions for performing the method of claim 1 and a processor, in communication with the memory for executing the instructions.

19. A system for determining parking availability, the system comprising:
a parking space determination device, the parking space determination device including:
a video capture module adapted to receive image data corresponding to a sequence of frames each capturing a parking area over a duration of time;
a stationary vehicle detection module adapted to detect a parked vehicle in the parking area as a change between a select frame and a background;
a background updating module adapted to estimate the background at a given instant of time by applying a predetermined updating factor in a process used to determine the background in each select frame;
a distance calculation module adapted to calculate an actual distance between the parked vehicle and one of an adjacent parked vehicle and a boundary of the parking area; and,
a processor adapted to implement the modules.

20. The system of claim 19, wherein the background updating module is adapted to compute a function Bₜ₊₁=p*Fₜ₊₁+(1−p)*Bₜ, wherein Bₜ is the background at time t, Fₜ₊₁ is the select frame at time t+1, and p is an image updating factor for a pixel, wherein the updating factor p varies depending on a classification of the pixel belonging to the foreground and background in the select frame, wherein the updating factor is selected from a group consisting,
a “0” value if a vehicle is detected at the pixel location;
a “1” value if another object is detected at a pixel location previously occupied by a vehicle; and,
a value 0≦p≦1 for all other pixels.

21. The system of claim 19, wherein the distance calculation module is further adapted to:
compute a pixel distance between a location of a vehicle element in the foreground image and an adjacent vehicle element in the foreground image; and,
map the pixel distance to the actual distance for estimating an actual length of the parking space.
